(19) United States
(12) Patent Application Publication
(10) Pub. No.: US 2005/0078337 A1
(43) Pub. Date: Apr. 14, 2005

(54) Image formation system and apparatuses used therein

(75) Inventors: Kazuhiro Ichikawa, Nagano (JP); Osamu Ishibashi, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/912,591

(22) Filed: Aug. 5, 2004

(30) Foreign Application Priority Data
Aug. 6, 2003 (JP) 2003-287905
Aug. 3, 2004 (JP) 2004-226747

(51) Int. Cl. G06F 3/12; G06F 15/00; H04B 7/00

(52) U.S. Cl. 358/1.15; 455/66.1

(57) ABSTRACT

The present invention provides an image formation system that is suitable for access by the general public. The image formation system 10 of the invention includes an image formation device 20 that forms an image on a medium and a portable device 80 that receives and sends information carried on electromagnetic waves in a preset frequency band. In the image formation system 10, the image formation device receives identification information of the portable device by the electromagnetic waves in the preset frequency band sent from the portable device 80 and is activated to be ready for image formation. Simple transmission of the identification information of the portable device activates the image formation device to be ready for image formation. The arrangement of this system 10 is accordingly suitable for access by the general public.

### BACKGROUND OF THE INVENTION

1. Field of the Invention

The present invention relates to an image formation system and apparatuses used therein. More specifically, the invention relates to an image formation system including an image formation device that forms an image on a medium, such as paper, and a portable device that receives and sends information carried on electromagnetic wave in a preset frequency band.

2. Description of the Prior Art

One proposed image formation system includes a printer and a management device that are mutually connected via a communication line. Multiple users may use the same printer in this proposed image formation system. The printer has a card reader to read identification information of each user from a card inserted therein and is activated in response to input of the identification information. The management device carries out an accounting process to calculate a charge for each piece of the identification information allocated to each user. The number of prints is stored in a storage element attached to a toner cartridge of the printer. The management device receives the number of prints from the printer via the communication line and carries out the accounting process.

### SUMMARY OF THE INVENTION

The prior art image formation system requires the card storing the identification information to activate and use the printer. This structure is not suitable for access to the printer by the general public. The quality of image formation as an output result of the printer generally depends upon the type and the status of the printer and the quality of an original image, but may not meet the user's requirements. The charge may thus be made for the user's undesired output result.

The object of the invention is thus to provide an image formation system that is suitable for access by the general public for image formation, as well as devices used in the image formation system and a corresponding image formation method. The object of the invention is also to provide an image formation system that forms the user's desired images, as well as devices used in the image formation system and a corresponding image formation method.

In order to achieve at least part of the aforementioned objects, the present invention is constructed as follows.

The present invention is directed to an image formation system which includes an image formation device that forms an image on a medium, such as paper, and a portable device that receives and sends information carried on electromagnetic wave in a preset frequency band. In the image formation system, the image formation device includes: an image formation device information reception/transmission module that receives and transmits information carried on the electromagnetic wave in the preset frequency band; an activation module that activates the image formation device to be ready for image formation, in response to reception of identification information of the portable device and a predetermined piece of startup information by the image formation device information reception/transmission module; an image formation condition acquisition module that, when the image formation device is activated in response to reception of the predetermined piece of startup information, sends a preset condition entry request to a sender, which has sent the predetermined piece of startup information, and acquires an image formation condition via the image formation device information reception/transmission module; and an image formation execution module that receives an image sent from the sender, which has sent the predetermined piece of startup information, as a response to a preset image transmission request via the image formation device information reception/transmission module and forms the received image on the medium under the acquired image formation condition. In the image formation system, the portable device includes: a portable device information reception/transmission module to receive and transmit information carried on the electromagnetic wave in the preset frequency band; an input module that is operated for entry of information; an identification information storage module that stores the identification information of the portable device; a startup information transmission control module that controls the portable device information reception/transmission module in response to entry of the predetermined piece of startup information by a specified operation of the input module to send the predetermined piece of startup information and the identification information of the portable device stored in the identification information storage module; an image formation condition transmission control module that controls the portable device information reception/transmission module to require an operator of the portable device for entry of the image formation condition in response to the preset condition entry request and send the image formation condition entered in response to the preset condition entry request; and an image transmission control module that controls the portable device information reception/transmission module to require the operator of the portable device for selection of the image in response to the preset image transmission request and send the image selected in response to the preset image transmission request.

Here the identification information of the portable device includes at least data for identifying the portable device. The data may be a combination of one or plurality of symbols, numerals, and letters. When the portable device is a cell phone, the identification information may include a telephone number of the cell phone.

The startup information includes data explicitly shown by the image formation device for its use and may be a combination of one or plurality of symbols, numerals, and letters. The startup information may include authentication data to give a permission of using the image formation system to the user of the portable device. The authentication data may be obtained in advance by the user of the portable device from an image formation management device, which manages the image formation device, via a communication system, prior to the use of the image formation device. The authentication data may alternatively be given to the user of the portable device according to an image formation system service agreement made by a system administrator of the image formation system.

In one preferable embodiment of the image formation system, the image formation device further includes an evaluation acquisition module that acquires evaluation information with regard to the image formed on the medium.

The evaluation acquisition module may acquire an evaluation given by the operator of the portable device. The image formation device of this structure has the evaluation acquisition module to acquire the operator's (user's) evaluation on the formed image (as an output result of the image formation device). The evaluation acquisition module may alternatively acquire an evaluation given by the image formation device. The image formation device scans the formed image and executes a patch process after image formation for self evaluation of the formed image.

Here the evaluation information includes a result of the user's acceptance or rejection of the formed image or a result of the user's good or bad quality judgment with regard to a selected factor, for example, brightness or sharpness of the image or a base evaluation factor like recording agent density, chromaticity, color balance, or print thickness. The evaluation acquisition module may show a window including evaluation request information on a display unit of the image formation device or an external display connecting with the image formation device. The evaluation acquisition module asks the user to enter the evaluation information in the window open on the display unit or the external display and accordingly obtains the evaluation information.

The evaluation acquisition module which acquires the evaluation given the operator may send a preset evaluation transmission request to the portable device and acquires the evaluation information with regard to the formed image via the image formation device information reception/transmission module. The portable device may include an evaluation provision module that requires the operator of the portable device for entry of the evaluation with regard to the formed image in response to reception of the preset evaluation transmission request and sends the evaluation information entered in response to the preset evaluation transmission request via the portable device information reception/transmission module.

The evaluation acquisition module which acquires the evaluation given by the image formation device may further include: a module that prepares a test pattern on an image carrier in the image formation execution module after formation of the image on the medium; a module that measures a recording agent density of the test pattern; and a module that evaluates the image formed on the medium based on the measured recording agent density. The evaluation acquisition module forms the test pattern, in response to reception an evaluation acquisition request sent from the portable device.

The evaluation acquisition module which acquires the evaluation given by the image formation device may include: an image scanning module that scans the image formed on the medium by the image formation execution module; and an evaluation module that makes an evaluation of the image formed on the medium based on an image density, which is extracted from the formed image scanned by the image scanning module.

In another preferable embodiment of the image formation system of the invention, the image formation device further includes an update module that modifies, adjusts, and updates the image formation condition set in the image formation device, based on an image density detected by the evaluation acquisition module. In this case, the image formation execution module may form the image again on the medium under the updated image formation condition, when the image formation condition set in the image formation device is updated.

In another preferable embodiment of the image formation system of the invention, the image formation device further includes an accounting module that carries out an accounting process based on a result of image formation by the image formation execution module and the evaluation information. When the acquired evaluation information includes a negative evaluation, the accounting module carries out the accounting process to at least reduce a charge for the result of image formation with the negative evaluation. The accounting process to at least reduce the charge may partially or fully invalidate or cancel the charge for the result of image formation. For example, the accounting process makes a discount or a refund on the charge.

In still another preferable embodiment of the image formation system, the image formation device further includes a specific information output module that outputs specific information, which is capable of specifying account information including the identification information of the portable device, a result of image formation by the image formation execution module, and the evaluation information, on the medium with the image formed thereon. The specific information may include date and time of the image formation. The specific information may include a number for identifying the image formation device, in addition to the date and time of the image formation. The specific information may include a symbol, a number, or a letter string allocated according to a predetermined rule or a combination thereof, instead of the date and time of the image formation.

In one preferable embodiment, the image formation system of the invention further includes an image formation management device that is connectable with the image formation device via a communication system. The image formation management device has: an account information acquisition module that acquires account information, which includes the identification information of the portable device, a result of image formation by the image formation execution module, and evaluation information corresponding to the result of image formation, from the image formation device via the communication system; and an accounting management module that carries out an accounting process based on the account information. The image formation device may gain an access to the image formation management device via the communication to give the account information to the image formation management device. The image formation management device may alternatively send an information request signal to the image formation device and obtain the account information from a certain memory of the image formation device. In this application, when the acquired evaluation information includes a negative evaluation, the accounting management module carries out the accounting process to at least reduce a charge for the result of image formation with the negative evaluation.

In the image formation system with the image formation management device, the image formation device may further include a specific information output module that outputs specific information, which is capable of specifying the account information including the identification information of the portable device, the result of image formation by the image formation execution module, and the evaluation information, on the medium with the image formed thereon, and the image formation management device may further include: a specific information acquisition module that obtains the specific information from the image formation device via the communication system; and an account information storage module that stores the account information in relation to the specific information that specifies the account information. The the image formation management device may still further include: a specific information input module that, in response to collection of a medium of image formation with a negative evaluation included in the evaluation information, inputs the specific information output on the medium; and a matching module that determines whether the specific information input by the specific information input module matches with the specific information that has been stored in the account information storage module in relation to the account information including the evaluation information of a negative evaluation.

The accounting management module carries out the accounting process to at least reduce a charge for the result of image formation with the negative evaluation, when a matching module determines that the input specific information matches with the stored specific information.

In one preferable structure of the image formation system having any of the above arrangements, the evaluation acquisition module of the image formation device sends a preset evaluation transmission request to the portable device and acquires the evaluation information with regard to the formed image via the image formation device information reception/transmission module. The portable device further has an evaluation provision module that requires the operator of the portable device for entry of the evaluation with regard to the formed image in response to reception of the preset evaluation transmission request and sends the evaluation information entered in response to the preset evaluation transmission request via the portable device information reception/transmission module.

The present invention is also directed to an image formation device that forms an image on a medium, such as paper, the image formation device including: an image formation device information reception/transmission module that receives and transmits information carried on electromagnetic wave in a preset frequency band; an activation module that activates the image formation device to be ready for image formation, in response to reception of identification information of a portable device and a predetermined piece of startup information by the image formation device information reception/transmission module; an image formation condition acquisition module that, when the image formation device is activated in response to reception of the predetermined piece of startup information, sends a preset condition entry request to a sender, which has sent the predetermined piece of startup information, and acquires an image formation condition via the image formation device information reception/transmission module; and an image formation execution module that receives an image sent from the sender, which has sent the predetermined piece of startup information, as a response to a preset image transmission request via the image formation device information reception/transmission module and forms the received image on the medium under the acquired image formation condition.

The image formation device of the invention may further include an evaluation acquisition module that acquires evaluation information with regard to the image formed on the medium. The evaluation acquisition module may send a preset evaluation transmission request to the portable device and acquire the evaluation information with regard to the formed image via the image formation device information reception/transmission module.

The image formation device may further include an accounting module that carries out an accounting process based on a result of image formation by the image formation execution module and the evaluation information. The accounting module, when the acquired evaluation information includes a negative evaluation, may carry out the accounting process to at least reduce a charge for the result of image formation with the negative evaluation.

The image formation device of the invention may output account information, which includes the identification information of the portable device, a result of image formation by the image formation execution module, and evaluation information corresponding to the result of image formation, to an image formation management device that is connectable with the image formation device via a communication system.

The image formation device of the invention may further include a specific information output module that outputs specific information, which is capable of specifying the account information including the identification information of the portable device, the result of image formation by the image formation execution module, and the evaluation information, on the medium with the image formed thereon.

The present invention is also directed to a portable device that sends and receives information carried on electromagnetic wave in a preset frequency band, to and from an image formation device that forms an image on a medium, such as a paper, the portable device including: a portable device information reception/transmission module to receive and transmit information carried on the electromagnetic wave in the preset frequency band; an input module that is operated for entry of information; an identification information storage module that stores the identification information of the portable device; a startup information transmission control module that controls the portable device information reception/transmission module in response to entry of a predetermined piece of startup information by a specified operation of the input module to send the predetermined piece of startup information and the identification information of the portable device stored in the identification information storage module; an image formation condition transmission control module that controls the portable device information reception/transmission module to require an operator of the portable device for entry of an image formation condition in response to a preset condition entry request and send the image formation condition entered in response to the preset condition entry request; an image transmission control module that controls the portable device information reception/transmission module to require the operator of the portable device for selection of an image in response to a preset image transmission request and send the image selected in response to the preset image transmission request; and an evaluation provision module that requires the operator of the portable device for entry of an evaluation with regard to a formed image in response to reception of a preset evaluation transmission request from the image formation device, and sends the evaluation information entered in response to the preset evaluation transmission request via the portable device information reception/transmission module.

The present invention is further directed to an image formation management device used in an image formation system which includes an image formation device that forms an image on a medium, such as paper, and a portable device that receives and sends information carried on electromagnetic wave in a preset frequency band. In the image formation system, the image formation device includes: an image formation device information reception/transmission module that receives and transmits information carried on the electromagnetic wave in the preset frequency band; an activation module that activates the image formation device to be ready for image formation, in response to reception of identification information of the portable device and a predetermined piece of startup information by the image formation device information reception/transmission module; an image formation condition acquisition module that, when the image formation device is activated in response to reception of the predetermined piece of startup information, sends a preset condition entry request to a sender, which has sent the predetermined piece of startup information, and acquires an image formation condition via the image formation device information reception/transmission module; an image formation execution module that receives an image sent from the sender, which has sent the predetermined piece of startup information, as a response to a preset image transmission request via the image formation device information reception/transmission module and forms the received image on the medium under the acquired image formation condition; and an evaluation acquisition module that acquires evaluation information with regard to result of the image formed on the medium. The image formation management device includes: an account information acquisition module that obtains account information, which includes the identification information of the portable device, a result of image formation by the image formation execution module, and evaluation information corresponding to the result of image formation, from the image formation device via the communication system; and an accounting management module that carries out an accounting process based on the account information. This image formation management device may be used in the image formation system in any of the embodiments described above.

In the image formation management device of the invention, the accounting management module, when the acquired evaluation information includes a negative evaluation, may carry out the accounting process to at least reduce a charge for the result of image formation with the negative evaluation.

The image formation in the image formation system may further include a specific information output module that outputs specific information, which is capable of specifying the account information including the identification information of the portable device, the result of image formation by the image formation execution module, and the evaluation information, on the medium with the image formed thereon. In this case, the image formation management device of the invention may further include: a specific information acquisition module that obtains the specific information from the image formation device via the communication system; and an account information storage module that stores the account information in relation to the specific information that specifies the account information.

The image formation management device of the invention may further include: a specific information input module that, in response to collection of a medium of image formation with a negative evaluation included in the evaluation information, inputs the specific information output on the medium; and a matching module that determines whether the specific information input by the specific information input module matches with the specific information that has been stored in the account information storage module in relation to the account information including the evaluation information of a negative evaluation.

The technique of the present invention is also applicable to an image formation method adopted in an image formation system. The image formation system includes an image formation device that forms an image on a medium, such as paper, and has an image formation device information reception/transmission module of receiving and sending information carried on electromagnetic wave in a preset frequency band, and a portable device that has a portable device information reception/transmission module of receiving and sending information carried on the electromagnetic wave in the preset frequency band.

The image formation method includes the steps of: (a) causing the portable device to send identification information of the portable device and a predetermined piece of startup information to activate the image formation device via the portable device information reception/transmission module to the image formation device; (b) activating the image formation device to be ready for image formation when the image formation device receives the identification information of the portable device and the predetermined piece of startup information via the image formation device information reception/transmission module; (c) sending a preset condition entry request to a sender, which has sent the predetermined piece of startup information, and acquiring an image formation condition carried on the electromagnetic wave in the preset frequency band; (d) forming an image on the medium under the acquired image formation condition, where the image carried on the electromagnetic wave in the preset frequency band has been sent from the portable device in response to a preset image transmission request and has been received by the image formation device; and (e) causing the image formation device to acquire evaluation information with regard to a result of image formation.

The image formation system that adopts the image formation method of the invention further includes an image formation management device that is connected with the image formation device via a communication system.

The image formation method further includes the step of: (f) carrying out an accounting process based on account information, which is obtained from the image formation device via the communication system and includes identification information of the portable device, the result of image formation, and the evaluation information.

In one preferable embodiment of the image formation method of the invention, when the acquired evaluation information includes a negative evaluation, the step (f) carries out the accounting process to at least reduce a charge for the result of image formation with the negative evaluation.

In another preferable embodiment of the image formation method of the invention, the step (d) forms the image on the medium and outputs specific information, which is capable of specifying the account information with regard to the image formation, on the medium.

The step (f) includes: an account information storing step of storing the account information obtained from the image formation device via the communication system in relation to the specific information obtained from the image formation device via the communication system; a specific information input step of, in response to collection of a medium of image formation with a negative evaluation included in the evaluation information, inputting the specific information output on the medium; and a matching step of determining whether the specific information input in the specific information input step matches with the specific information that has been stored in the account information storing step in relation to the account information including the evaluation information of a negative evaluation. When the input specific information matches with the stored specific information in the matching step, the image formation method carries out the accounting process to at least reduce the charge for the result of image formation with the negative evaluation.

In another preferable embodiment of the image formation method of the invention, the step (e) causes the image formation device to acquire the evaluation information with regard to the formed image from the portable device by the electromagnetic wave in the preset frequency band, in response to a preset evaluation transmission request on the image formed on the medium.

In any of the image formation system, the image formation device, the portable device, and the image formation method discussed above, the predetermined piece of startup information includes authentication data. The authentication data desirably prevents any unauthorized user of the portable device from illegally using the image formation device and thus gives permissions to only authorized and legal use. In any of the arrangements of the present invention, the electromagnetic wave in the preset frequency band preferably includes electromagnetic waves in a frequency band used for communication of cell phones.

In any of the arrangements of the present invention, the image formation device may include an accounting module that carries out an accounting process for image formation.

In any of the arrangements of the present invention, it is preferable that the image formation device is designed to send the account information and the evaluation information to the portable device via the image formation device information reception/transmission module. It is also preferable that the user of the portable device sends the account information and the evaluation information to the image formation management device via the portable device information reception/transmission module and the communication system.

In one preferable embodiment, the image formation device having the specific information output module has a timer of measuring the date and time, and the specific information includes the date and time of image formation. When the specific information includes the date and time of image formation, both the user and a system administrator can readily identify each formed image.

### BRIEF DESCRIPTION OF THE DRAWINGS

FIG. 1 schematically illustrates the configuration of an image formation system 10;

FIG. 2 schematically illustrates the internal structure of an information transmission module 50 and a cell phone 80;

FIG. 3 schematically illustrates the structure of a color laser printer 20;

FIG. 4 is a block diagram showing input and output of control signals to and from a controller 60;

FIGS. 5 through 7 shows a series of an image formation process;

FIG. 8 is a flowchart showing a activation process;

FIG. 9 is a flowchart showing a print execution process;

FIG. 10 shows a printing information entry window;

FIG. 11 is a flowchart showing an evaluation acquisition process;

FIG. 12 shows an evaluation entry window;

FIG. 13 is a flowchart showing an accounting process;

FIG. 14 is a flowchart showing a matching process;

FIG. 15 is a flowchart showing an ordinary accounting process;

FIG. 16 is a flowchart showing a refunding process after collection of medium;

FIG. 17 is a flowchart showing a print execution process in a second embodiment;

FIG. 18 is a flowchart showing an evaluation acquisition process in the second embodiment;

FIG. 19 schematically illustrates the structure of a color laser printer 120 in the second embodiment; and

FIG. 20 is a flowchart showing an evaluation acquisition process in a third embodiment.

### DESCRIPTION OF THE PREFERRED EMBODIMENTS

Some modes of carrying out the invention are discussed below as preferred embodiments.

First Embodiment

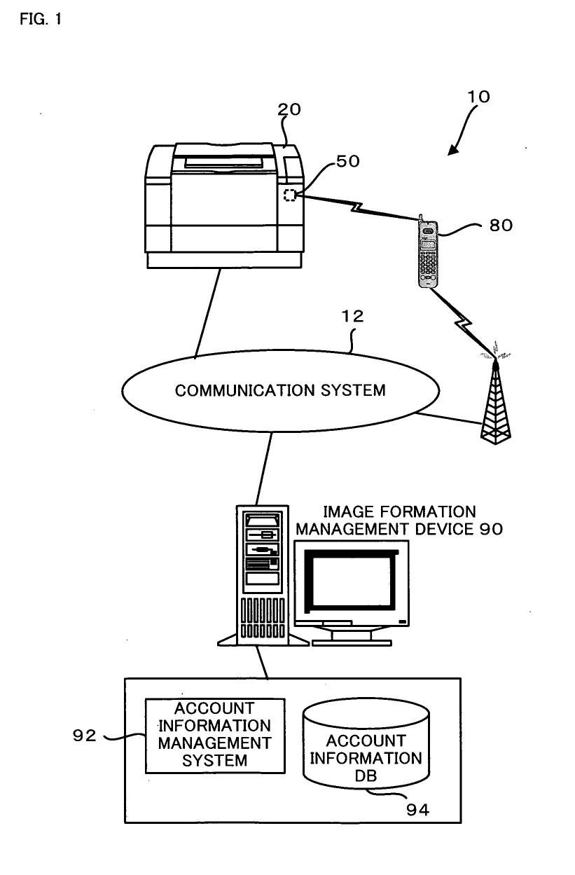

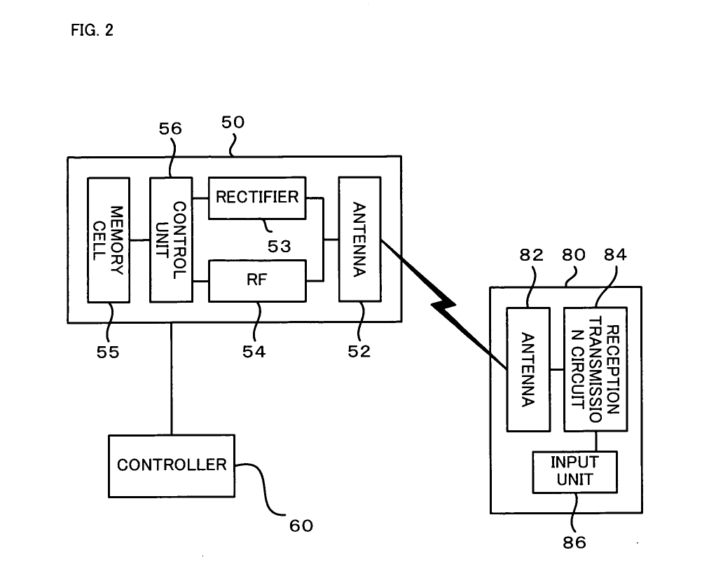

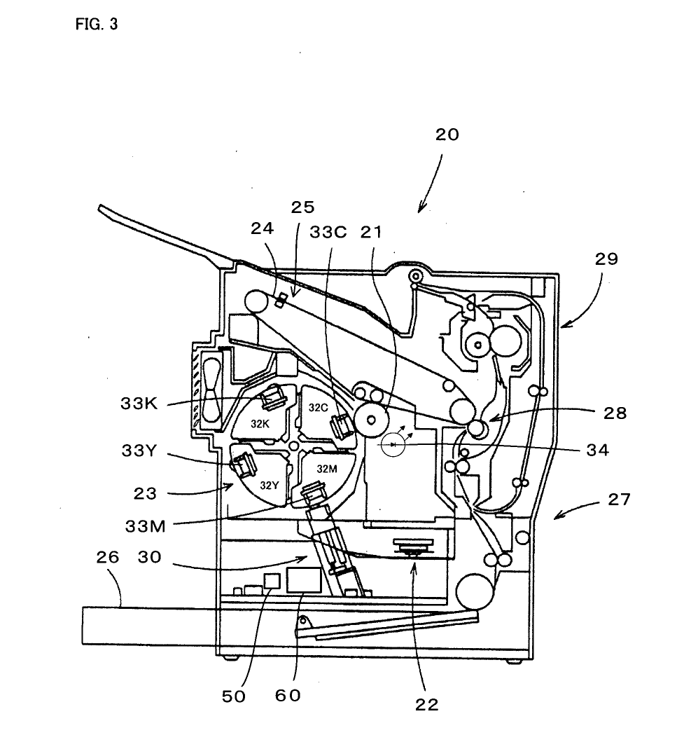

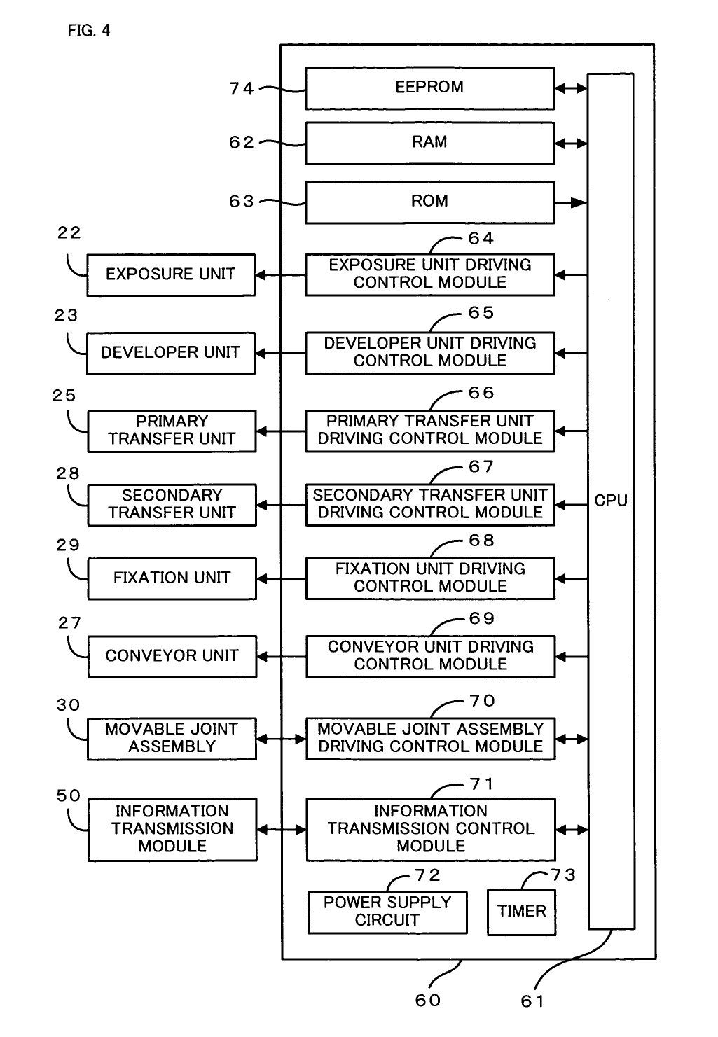

FIG. 1 schematically illustrates the configuration of an image formation system in a first embodiment of the invention. FIG. 2 schematically illustrates the internal structure of an information transmission module 50 in a color laser printer 20 included in the image formation system 10 of the first embodiment and a related module of a cell phone 80 involved in transmission of information to and from the information transmission module 50. FIG. 3 schematically illustrates the structure of the color laser printer 20. FIG. 4 is a block diagram showing input and output of control signals to and from a controller 60 in the color laser printer 20. As shown in FIG. 1, the image formation system 10 of the first embodiment includes the printer 20 that has the information transmission module 50 and functions as an image formation device, the cell phone 80 that functions as a portable device to make contactless transmission of information to and from the information transmission module 50, and a management device 90 that is connected with the printer 20 and the cell phone 80 via a communication system.

The color laser printer 20 is constructed as a full-color electrophotographic image formation device of the single photoreceptor system and the intermediate transfer system. As shown in FIG. 3, the color laser printer 20 includes an exposure unit 22 that forms four color component images of cyan (C), magenta (M), yellow (Y), and black (K) as electrostatic latent images on a charged photoreceptor 21 by laser irradiation, a developer unit 23 that uses corresponding color toners fed from respective color toner cartridges 32C, 32M, 32Y, and 32K attached to the color laser printer 20 to develop the electrostatic latent images formed on the photoreceptor 21 as color toner images, and a primary transfer unit 25 that transfers the respective color toner images developed on the photoreceptor 21 to a transfer belt 24 in an overlapping manner to form a composite color toner image. The color laser printer 20 also includes a conveyor unit 27 that conveys each sheet of printing paper from a paper cassette 26, a secondary transfer unit 28 that transfers the composite color toner image formed on the transfer belt 24 to the conveyed sheet of printing paper, a fixation unit 29 that fuses and fixes the transferred composite color toner image on the sheet of printing paper and discharges the sheet of printing paper with the fixed color toner image, a movable joint assembly 30 that is linked to each of storage elements 33C, 33M, 33Y, and 33K attached to the color toner cartridges 32C, 32M, 32Y, and 32K with rotation of the developer unit 23 to read information on, for example, the color of the toner kept in the toner cartridge, the information transmission module 50 that transmits information to and from the cell phone 80, and a controller 60 that controls the operations of the whole color laser printer 20. This embodiment regards the image formation device of the single photoreceptor system and the intermediate transfer system. The image formation device may have another structure and, for example, may adopt a tandem system having photoreceptors and developer units provided for the respective colors.

As shown in FIG. 4, the controller 60 is constructed as a microcomputer including a CPU 61, a RAM 62, a ROM 63, and an EEPROM 74 and receives measurement or detection results from various sensors (for example, a color density sensor 34 and a temperature sensor) and diversity of other input signals (for example, a print instruction signal given by a user) via signal lines. In response to these input signals, the controller 60 controls the operations of the respective constituents of the color laser printer 60, that is, the exposure unit 22, the developer unit 23, the primary transfer unit 25, the secondary transfer unit 28, the fixation unit 29, the conveyor unit 27, and the movable joint assembly 30 via an exposure unit driving control module 64, a developer unit driving control module 65, a primary transfer unit driving control module 66, a secondary transfer unit driving control module 67, a fixation unit driving control module 68, a conveyor unit driving control module 69, and a movable joint assembly driving control module 70. The controller 60 further includes an information transmission control module 71 that controls transmission of information to and from the information transmission module 50, a power supply circuit 72, and a timer 73.

With reference to FIG. 2, the information transmission module 50 has an antenna 52 that utilizes electromagnetic waves in a preset frequency band, which is generally used for reception and transmission of signals in the cell phone 80 (for example, electromagnetic waves in a 800 MHz band, in a 1.56 GHz band, or a 1.9 GHz band, hereafter referred to as the electromagnetic waves in the information reception/transmission frequency band), to receive and sent signals, a rectifier 53 that rectifies the received electromagnetic waves and outputs the energy of the rectified electromagnetic waves as electric power, a signal analyzing RF (Radio Frequency) 54 that analyzes the received signals, a memory cell 55 that stores information, and a control unit 56 that outputs signals to the controller 60 based on the information included in the received signals and outputs signals via the antenna 52 under control of the controller 60. When a signal received via the antenna 52 and analyzed by the signal analyzing RF 54 includes preset printer service information, identification information of the portable device, and authentication data for permission of the use of the printer, the control unit 56 outputs a start signal of activating the printer 20 to be ready for image formation via the information transmission control module 71 to the controller 60. The control unit 56 also transmits diverse signals via the antenna 52 under control of the information transmission control module 71.

In the information transmission module 50 of the above structure, the antenna 52 receives a preset transmission signal carried on the electromagnetic waves in the information reception/transmission frequency band. The signal analyzing RF 54 analyzes the received transmission signal and determines whether the analyzed transmission signal includes service information of the printer 20, identification information of the cell phone 80, and authentication data for permission of the use of the printer 20 that are identical with corresponding pieces of information and data stored in the memory cell 55. When the transmission signal includes such information and data, the control unit 56 sends the start signal of the printer 20 to the controller 60 via the information transmission control module 71.

As shown in FIG. 2, the cell phone 80 has an antenna 82 and a reception transmission circuit 84 that are used to receive and send signals by the electromagnetic waves in the information reception/transmission frequency band, and an input unit 86 that is manipulated for entry of figures, letters, and characters, as well as diversity of elements generally included in the cell phone. The cell phone 80 transmits information to and from the information transmission module 50, while establishing communication and making phone calls with other devices via the communication system 12.

With reference to FIG. 1, the image formation management device 90 functions as a server connecting with the communication system 12 and includes a system and a database used to manage diverse pieces of information obtained from the printer 20, that is, an account information management system 92 to manage account information and an account information management database 94 to store data used in the account information management system 92.

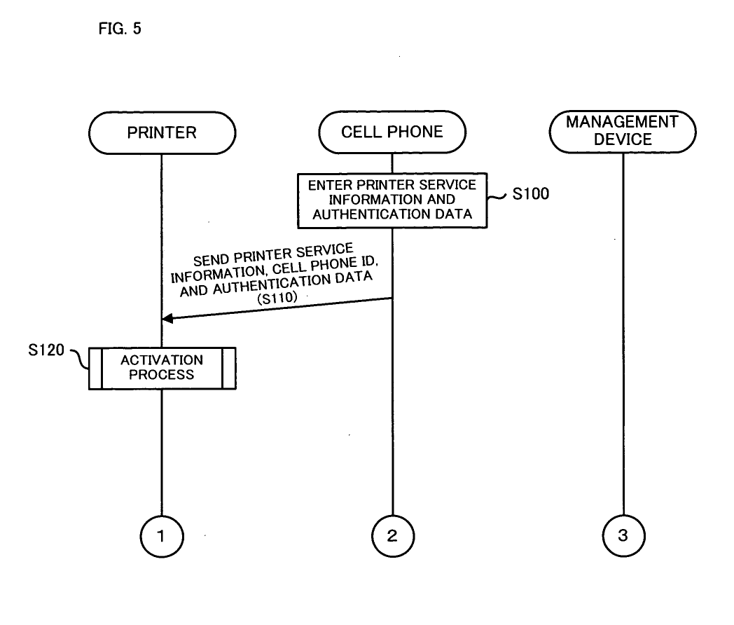

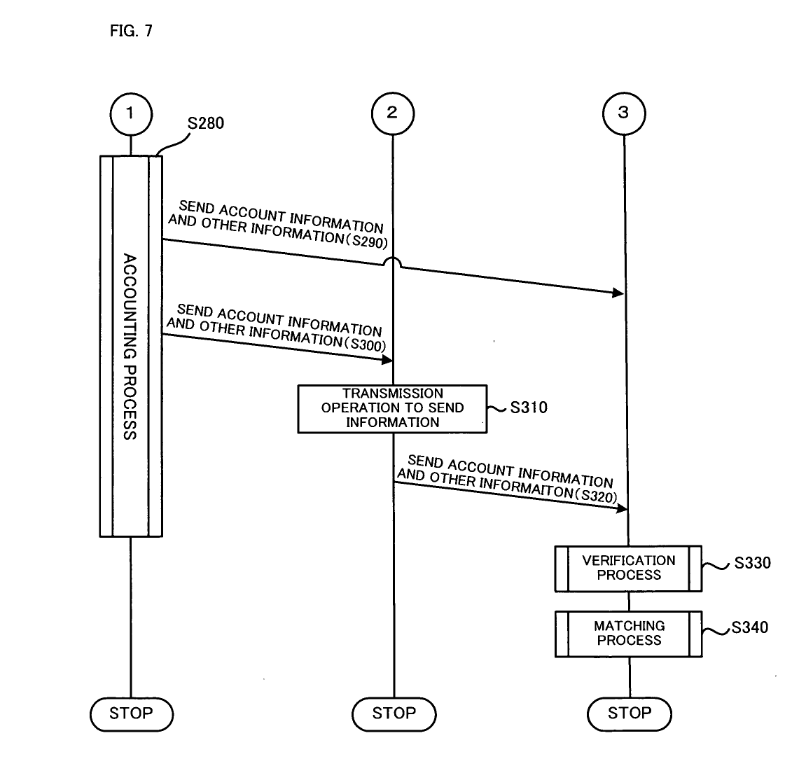

The following describes the operations of the image formation system 10 of the first embodiment having the configuration discussed above. FIGS. 5 to 7 show a sequence of the processing executed by the respective constituents, for example, the color laser printer 20 and the cell phone 80, of the image formation system 10 of the first embodiment and intercommunication among the respective constituents. The following description regards a series of operations executed when the color laser printer 20 prints multiple images obtained by the cell phone 80 via the Internet.

The user first manipulates the input unit 86 of the cell phone 80 to enter printer service information that allows the color laser printer 20 to recognize signal transmission for the use of the printer 20, and authentication data that has been acquired in advance for permission of the use of the printer 20, and presses a ‘Send’ button on the cell phone 80 (step S100). The cell phone 80 also executes processing in this transmission operation to send a cell phone ID as the identification information of the cell phone 80, in addition to the input information and data. In response to this transmission operation, the input printer service information, the input authentication data, and the cell phone ID (hereafter the printer service information and the authentication data may collectively be referred to as startup information) carried on the electromagnetic waves in the information reception/transmission frequency band are sent via the antenna 82 to the printer 20 (step S110).

The printer service information may be any adequate piece of information and is a 4-digit number, which is displayed with a sentence ‘The printer service number is given as:’ in the periphery of an operation panel of the color laser printer 20 in this embodiment. The user manipulates the input unit 86 of the cell phone 80 to enter the 4-digit number displayed as the printer service information in the vicinity of the operation panel of the color laser printer 20 and then presses the ‘Send’ button. The identification information of the cell phone 80 is not restricted to the cell phone ID but may be an ID given exclusively for the image formation system. The authentication data may be exclusive authentication data obtained by the cell phone 80 from the image formation management device 90 of the image formation system 10 prior to the use of the color laser printer 20, or non-exclusive authentication data given to the cell phone 80 according to an image formation system service agreement made by the image formation system or with a cell phone company. The startup information may be either or both of the printer service information and the authentication data. In this embodiment, the startup information includes both the printer service information and the authentication data. The authentication data has been obtained and stored in advance by the controller 60 of the color laser printer 20.

The operation routine of this embodiment sends the printer service information, the cell phone ID, and the authentication data all together. One modified operation routine may first send only the printer service information and the cell phone ID to be checked by the color laser printer 20, and subsequently send the authentication data in response to a request for the authentication data from the color laser printer 20.

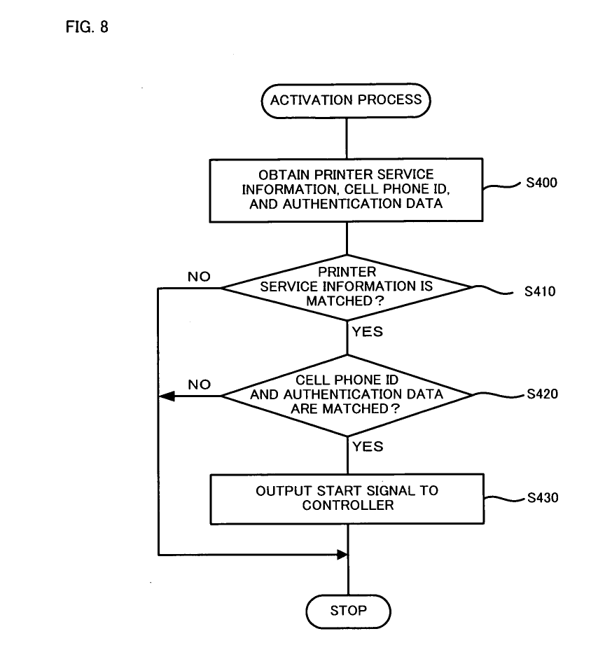

In the information transmission module 50 of the color laser printer 20, when the antenna 52 receives the electromagnetic waves in the information reception/transmission frequency band, the rectifier 53 supplies the energy of the rectified electromagnetic waves as electric power and the control unit 56 executes an activation process (step S120). FIG. 8 shows a flow of the activation process. In this activation process, the control unit 56 first obtains the printer service information, the cell phone ID, and the authentication data from the signal analyzed by the signal analyzing RF 54 (step S400). The control unit 56 then determines whether the obtained printer service information is identical with the printer service information stored in the memory cell 55 (step S410). When the input printer service information is matched with the stored information, the control unit 56 subsequently determines whether the obtained cell phone ID and authentication data are identical with the corresponding data stored in the memory cell 55 (step S420) When both the cell phone ID and the authentication data are matched with the stored data, the control unit 56 outputs the start signal for activating the printer 20 to the information transmission control module 71 of the controller (step S430). The activation process is then terminated. The authentication data may be obtained from the controller 60 via the information transmission control module 71. In the latter structure, the printer 20 is required to stand by for reception of information with a required level of power supply to the control system including the controller 60.

When the input printer service information or the authentication data is mismatched, on the other hand, the activation process is terminated immediately without any further processing. In the case of mismatched printer service information or authentication data, another applicable procedure sends from the antenna 52 a signal carried on the electromagnetic waves in the information reception/transmission frequency band to demand for reentry and retransmission of the required information and data, prior to termination of the activation process.

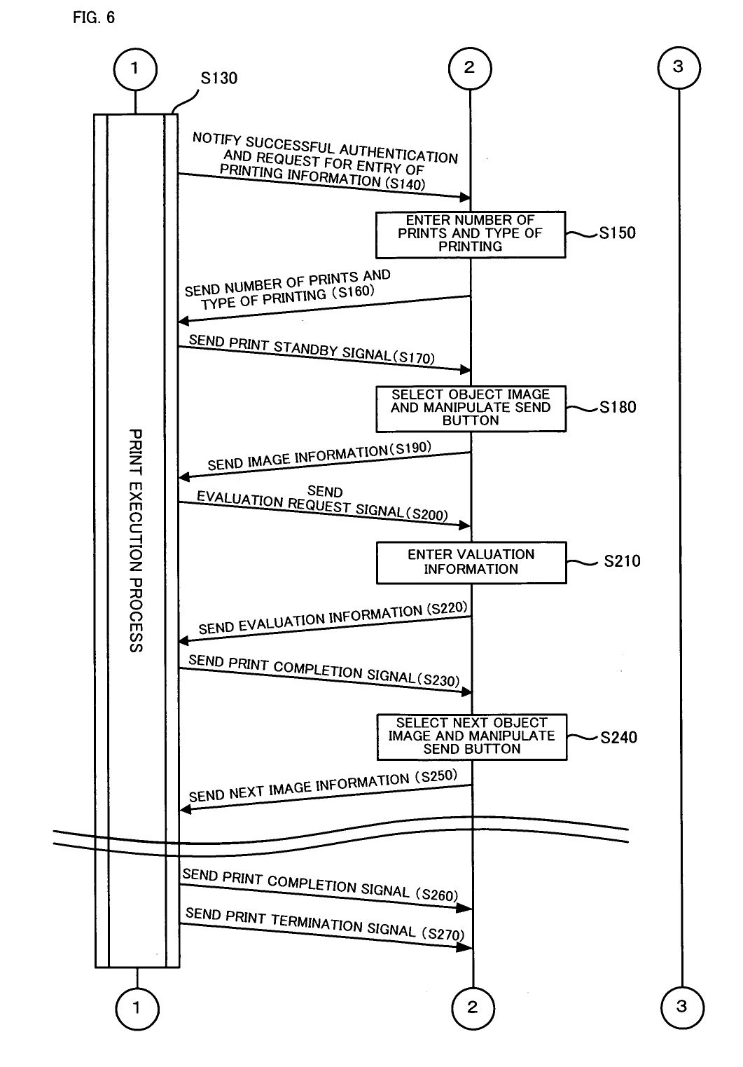

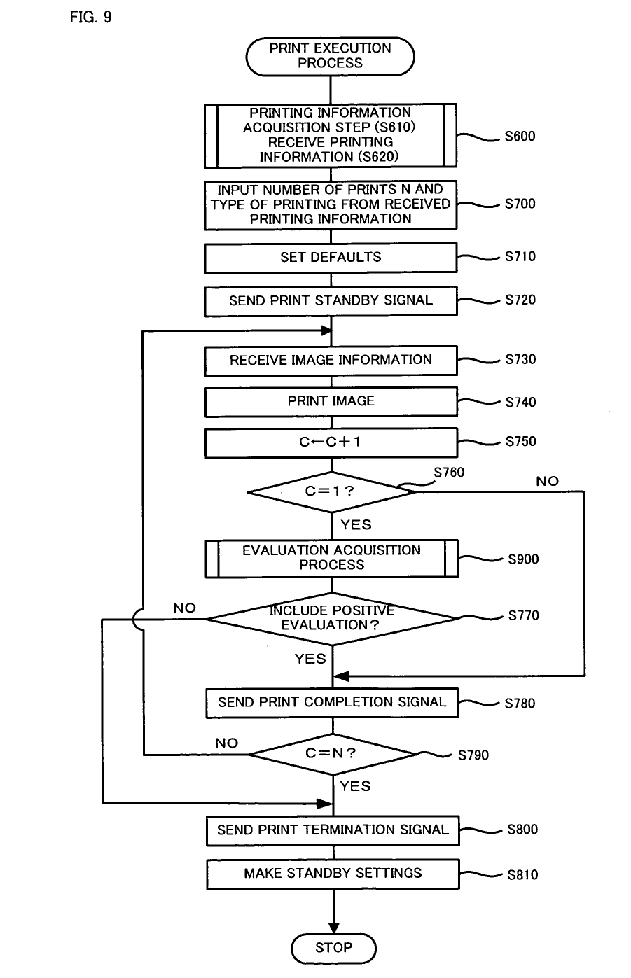

The controller 60 receiving the start signal initiates supply of electric power from the power supply circuit 72 to the respective units, modules, and elements, while controlling the control unit 56 of the information transmission module 50 to keep the status of receiving and sending information from and to the cell phone 80. The controller 60 then executes a print execution process (step S130). FIG. 9 shows a flow of the print execution process. The print execution process includes a subsequent series of processing executed by the color laser printer 20 for transmission of information to and from the cell phone 80. The print execution process is described with reference to the flowcharts of FIGS. 6 and 9.

When the print execution process starts, the controller 60 first acquires printing information required for formation of an image (step S600). The controller 60 sends a signal of notification of successful authentication and permission for the use of the printer 20 and a signal of request for entry of printing information, which are carried on the electromagnetic waves in the information reception/transmission frequency band, from the antenna 52 to the cell phone 80 (steps S610 in FIG. 9 and step S140 in FIG. 6).

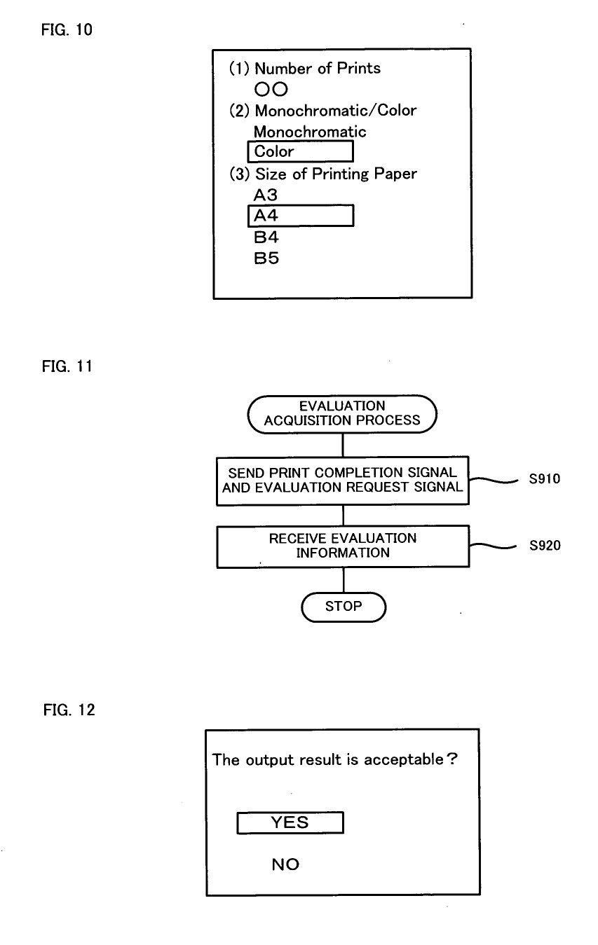

In response to reception of these signals at the antenna 82, the cell phone 80 receives entry of the printing information including the number of prints and the type of printing (step S150). FIG. 10 shows a printing information entry window open on the screen of the cell phone 80 for entry of the number of prints and the type of printing. The type of printing includes selection of either monochromatic printing or color printing and selection of the size of printing paper. When the user manipulates the input unit 86 of the cell phone 80 to enter the number of prints and the type of printing and presses the ‘Send’ button, these pieces of printing information are carried on the electromagnetic waves in the information reception/transmission frequency band and are sent from the antenna 82 to the color printer 20 (step S160). The controller 60 receives these pieces of printing information via the antenna 52 (step S620 in FIG. 6). This completes the printing information acquisition step.

In the system of this embodiment, the printing information acquisition step (steps S600 and S610) is part of the print execution process. This is, however, not restrictive at all. The printing information may be acquired at any step in the processing flow up to print execution through transmission of the electromagnetic waves with information carried thereon from the cell phone 80 and reception of the electromagnetic waves by the color laser printer 20. For example, the cell phone 80 may send the printing information simultaneously with the identification information and the authentication data. The cell phone 80 may alternatively send the printing information at a different timing from transmission of the identification information and the authentication data to the color laser printer 20.

The CPU 61 of the controller 60 inputs the number of prints N and the type of printing from the acquired printing information (step S700), sets defaults for execution of printing corresponding to the input type of printing (step S710), and sends a print standby signal to the cell phone 80 (step S720 and step S170 in FIG. 6). The print standby signal is carried on the electromagnetic waves in the information reception/transmission frequency band and is sent from the antenna 52 via the information transmission control module 71 and the control unit 56.

In response to reception of the print standby signal, the user of the cell phone 80 selects an object image to be printed and presses the ‘Send’ button (step S180) to send image information representing the selected object image (step S190) The color laser printer 20 receives the image information via the antenna 52, the control unit 56, and the information transmission control module 71 (step S730) and prints the object image of the received image information corresponding to the input type of printing (step S740).

In the course of printing the selected object image of the image information, the date and time of reception of the image information or the date and time of printing is simultaneously output to a medium, on which the object image is printed. For example, the timer 73 of the controller 60 measures and stores the date and time of reception of the image information. The date and time of reception of the image information or the date and time of printing is printed on a specified part of the medium, for example, on a rear face of the medium. The date and time is utilized later as specific information for specifying the cell phone 80 as the source of the image information and a result of accounting for image printing.

On completion of printing the first object image, the print execution process increments a counter C, which is reset to zero by the default setting at step S710, by one (step S750) and determines whether the incremented counter C is equal to 1 (step S760). When the counter C is equal to 1, that is, in the case of completion of printing the first object image, the controller 60 executes an evaluation acquisition process (step S900).

A flow of the evaluation acquisition process is shown in FIG. 11. The evaluation acquisition process sends a request signal for evaluation of the printing image to the cell phone 80 (step S910 in FIG. 11 and step S200 in FIG. 6). The cell phone 80 receives the request signal via the antenna 82 and receives entry of evaluation information representing acceptance or rejection of the printed image or representing acceptable printing quality or unacceptable printing quality (step S210 in FIG. 6). The user generally checks the printed image with eyes for evaluation. FIG. 12 shows an evaluation entry window open on the screen of the cell phone 80 for entry of acceptance or rejection of the printed image. In one modified structure, the evaluation information may include multiple evaluation items, for example, the density of the recording agent, the brightness, the sharpness, the thickness of letters and characters, and the tint. The user makes evaluations on the respective evaluation items. Any suitable method is adopted for the evaluation, for example, multiple-choice including either-or choice or point rating. The user manipulates the input unit 86 of the cell phone 80 to enter the evaluation information and presses the ‘Send’ button. The evaluation information carried on the electromagnetic waves in the information reception/transmission frequency band is then sent from the antenna 82 to the color laser printer 20 (step S220 in FIG. 6). In the color laser printer 20, the controller 60 receives the evaluation information via the antenna 52 (step S920). This completes the evaluation acquisition process.

The print execution process determines whether the acquired evaluation information includes a positive evaluation, for example, acceptance of the printed image (step S770). When the received evaluation information includes a positive evaluation, the print execution process continues printing to make the residual number of prints. In the case of the positive evaluation, the print execution process sends a print completion signal (step S780 in FIG. 9 and step S230 in FIG. 6), and compares the counter C incremented at step S750 with the specified number of prints N (step S790). When the counter C is not identical with the specified number of prints N, the print execution process determines that printing of the specified number of prints N has not yet been concluded and goes back to step S730 to receive next image information. Selection of a next object image to be printed is allowed for the user of the cell phone 80 in the same manner as step S180. The user selects a next object image and presses the ‘Send’ button (step S240) to send image information representing the selected next object image to the color laser printer 20 (step S250). The color laser printer 20 prints the next object image of the received image information (step S740) and increments the counter C by one (step S750). In the case of printing the second or subsequent object image, the incremented counter C is equal to 2 or greater at step S760. In this case, the print execution process skips the evaluation acquisition process (step S900), and immediately sends the print completion signal (step S780) and determines whether the counter C is identical with the specified number of prints N (step S790).

On completion of printing the specified number of prints N by the color laser printer 20, the counter C is identical with the number of prints N at step S790. The print execution process accordingly sends a print termination signal to the cell phone 80 (step S800 and step S270 in FIG. 6) and makes standby settings to stop the supply of electric power from the power supply circuit 72 to the respective units, modules, and elements and to set the color laser printer 20 in the standby state prior to execution of the activation process at step S120 (step S810), before being terminated.

When the evaluation information decision step (step S770) shows that the acquired evaluation information includes a negative evaluation, for example, rejection of the printed image, on the other hand, the print execution process immediately sends the print termination signal to the cell phone 80 (step S800) and makes standby settings (step S810), before being terminated. In the case of the negative evaluation, one modified procedure may send an inquiry signal for continued printing via the antenna 82 to the cell phone 80, receive a response to the inquiry from the cell phone 80 via the antenna 82, and terminate the evaluation information acquisition process in the response of continued printing.

The procedure of this embodiment carries out the evaluation acquisition process with regard to only the first printed image. The evaluation acquisition process may be executed with regard to each printed image according to the requirements. The evaluation acquisition process may otherwise be executed with regard to only each desired image for evaluation. In the system of this embodiment, the evaluation acquisition process is part of the print execution process. This is, however, not restrictive at all. One modified procedure may terminate the print execution process after printing each object image or after printing all object images and subsequently carry out the evaluation acquisition process.

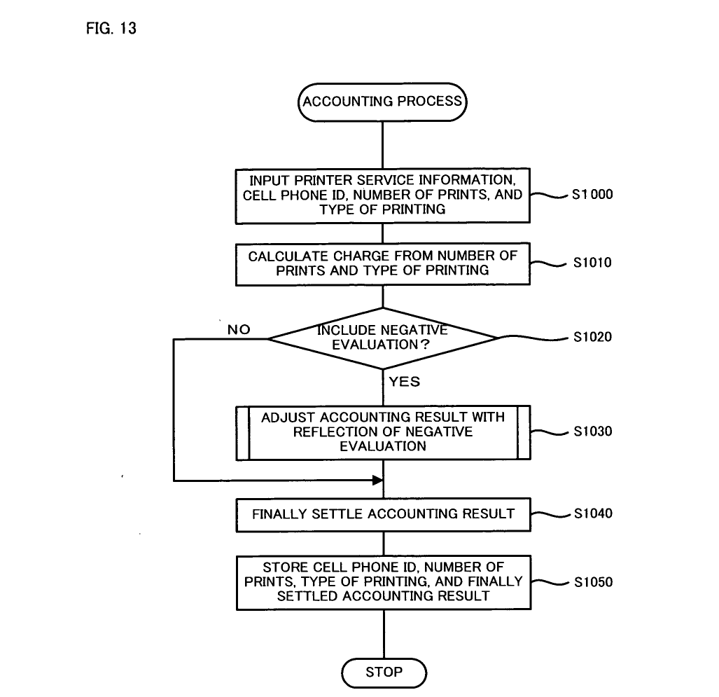

After termination of the print execution process, the color laser printer 20 executes an accounting process, based on the printing information including the number of prints and the type of printing (step S280). FIG. 13 shows a flow of the accounting process. The accounting process first inputs the specific information, the number of prints, the type of printing, and the evaluation information obtained in the print execution process, as well as the cell phone ID and the authentication data (step S1000), and calculates a charge from the number of prints and the type of printing (step S1010). The accounting process then determines whether the input evaluation information includes a negative evaluation of any printed image (step S1020). When the input evaluation information includes no negative evaluation, the calculated charge is set to a finally settled accounting result (step S1040). When the input evaluation information includes any negative evaluation, on the other hand, the calculated charge is adjusted by, for example, making a partial or full discount on each printed image with a negative evaluation (step S1030). The adjusted charge is then set to the finally settled accounting result (step S1040). The finally settled accounting result with reflection of the evaluation information, the cell phone ID, the authentication data, and the printing information including the number of prints and the type of printing are collectively set to account information. The account information is stored together with the evaluation information and the specific information into the memory (step S1050). The accounting process is then terminated. The charge is calculated, for example, by multiplying the number of prints by a unit price of each specified type of printing, that is, a unit price corresponding to each combination of selected monochromatic printing or color printing and the selected size of printing paper.

The procedure of this embodiment stores the evaluation information and the specific information together with the account information into the memory cell. One modified procedure may set a correlation and separately store the account information from the evaluation information and the specific information.

The account information, the evaluation information, and the specific information stored in the color laser printer 20 are sent from the color laser printer 20 to the image formation management device 90 via the communication system 12 (step S290). Data transmission from the color laser printer 20 is preferably carried out at preset time intervals, for example, once a day. In one modified structure, the image formation management device 90 occasionally gains access to the color laser printer 20 via the communication system 20 to fetch desired pieces of information from the controller 60 of the color laser printer 20.

The color laser printer 20 sends the account information including the accounting result, the evaluation information, and the specific information carried on the electromagnetic waves in the information reception/transmission frequency band to the cell phone 80 (step S300). The user accordingly keeps the account information in the cell phone 80. The user of the cell phone 80 carries out a preset transmission operation (step S310) to send the account information, the evaluation information, and the specific information carried on the electromagnetic waves in the information reception/transmission frequency band to the image formation management device 90 via the communication system 12 (step S320). The cell phone 80 utilizes the electromagnetic waves in the information reception/transmission frequency band to establish connection with the communication system 12 and send the account information and the other pieces of information to the image formation management device 90. The image formation management device 90 can then manage the account information and the other pieces of information without continuous connection of the color laser printer 20 to the communication system 12.

The image formation management device 90 receives the account information, the evaluation information, and the specific information and manages and stores these received pieces of information by the account information management system 92 and in the account information database 94. The management system 92 and the database 94 store the evaluation information and the specific information in relation to the account information.

The image formation management device 90 including the management system 92 and the database 94 validates the account information in combination with the evaluation information and the specific information to verify the adequacy of image formation and the adequacy of the accounting result (step S330) In the verification process, the system administrator of the image formation system checks the evaluation information stored in the database 94 and obtains the frequency of appearance of the negative evaluation given to the color laser printer 20. The requirement for maintenance of the color laser printer 20 may be determined, based on the frequency of appearance of the negative evaluation. The image formation management device 90 registers the result of verification in relation to the specific information into the database 94. In one modified structure, the account information, which is correlated to the specific information, is extracted with the specific information given to the medium as a key from the database 94, and the result of verification is stored with the extracted account information in the database 98. The system administrator of the image formation system may collect printed images rejected with negative evaluations and thoroughly examine the cause of the negative evaluation on each rejected image formation and the validity of the negative evaluation.

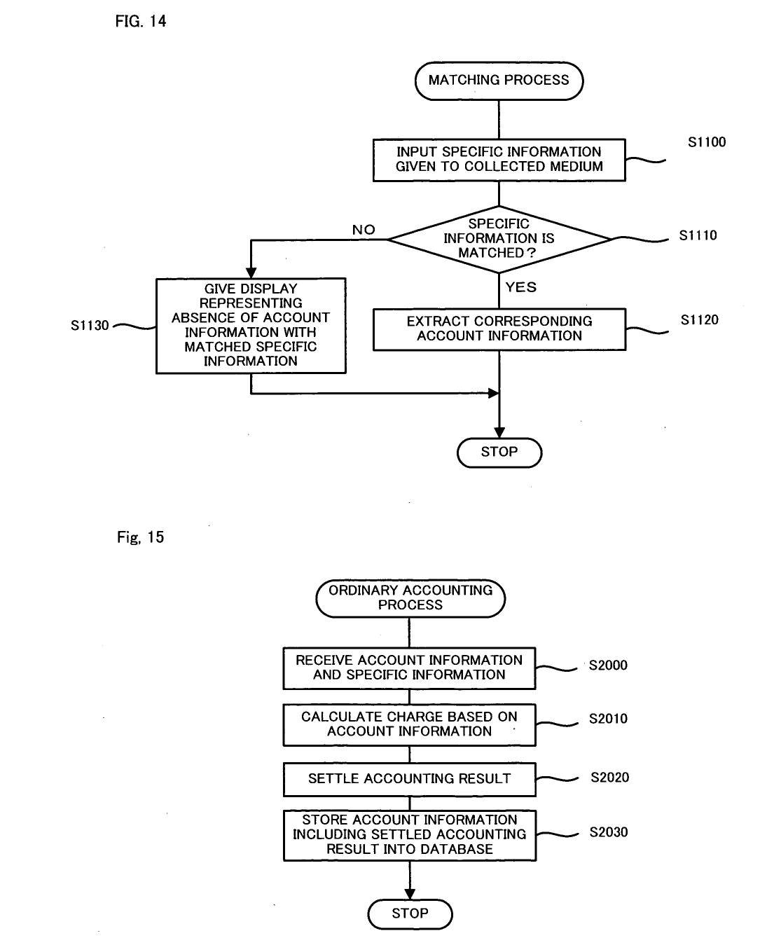

The image formation management device 90 carries out a matching process, in addition to the verification process. A flow of the matching process (step S340) is shown in FIG. 14. In the matching process, the image formation management device 90 inputs the specific information from each collected medium (step S1100). The image formation management device 90 then retrieves the database 94 to determine whether the input specific information is identical with the specific information in relation to the account information that includes a negative evaluation and is received from the color laser printer 20 and stored in the database 94 with either the input specific information or the stored specific information as a key (step S1110). When the two pieces of the specific information are matched, the image formation management device 90 extracts the account information corresponding to these pieces of the specific information (step S1120) and terminates the matching process. In the case of matched specific information, it is automatically confirmed that the printed image with a negative evaluation is collected successfully. When the two pieces of the specific information are mismatched, on the other hand, the image formation management device 90 gives a display representing mismatch of the specific information (step S1130) and terminates the matching process. Such mismatch automatically shows failure of collection of the printed image with a negative evaluation. The result of the matching process (step S340) is utilized to verify the adequacy for collection of the printed image rejected with the negative evaluation.

The image formation management device 90 may use the result of the matching process (step S340) to finally settle the accounting result with reflection of the negative evaluation. The image formation management device 90 finally settles the accounting result with reflection of the negative evaluation, that is, the accounting result adjusted to make a partial or full discount on the rejected image formation, only when the specific information input from the collected medium is matched with the specific information in relation to the account information that includes a negative evaluation and is received from the color laser printer 20 and stored in the database 94 in the matching process (step S340). (In this arrangement, the accounting result with reflection of the negative evaluation is not settled until collection of the medium). The image formation management device 90 inputs the specific information given to each collected medium of the printed image rejected with the negative evaluation and settles the accounting result with reflection of the negative evaluation. This arrangement enables the evaluation information in the evaluation system to be adequately reflected on the accounting system. The negative evaluation given to a printed image may be regarded as a discount claim for the charge of the printed image. In one modified procedure, the image formation management device 90 first settles the accounting result without reflection of the negative evaluation and charges the user for all the printed images. The image formation management device 90 then makes a discount (a refund) on the charge after extraction of the specific information from the collected medium with the rejected image formation and confirmation of the negative evaluation.

The image formation management device 90 extracts the account information, which has been registered in the database 98 in the previous month, at the beginning of every month, sums up the charges for each cell phone ID, and notifies the user identified by the cell phone ID of the total sum of the charges.

As described above, in the image formation system 10 of the embodiment, the user of the cell phone 80 sends the electromagnetic waves with information carried thereon to activate the color laser printer 20. This system is suitable for the access to the color laser printer 20 by the general public for image formation. The user is allowed to evaluate printed images as results of image formation and reject any unsatisfactory images. The user can thus gain only desired images with the color laser printer 20 installed to be acceptable by the general public. This system enables the color laser printer 20 to be installed at, for example, a convenience store or in a shopping mall and to be acceptable by the general public.

In the image formation system 10 of the first embodiment, the color laser printer 20 and the antenna 52 of the information transmission module 50 respectively correspond to the image formation device and the information reception/transmission module for the image formation device of the invention. The activation process shown in the flowchart of FIG. 8 and the information transmission module 50 executing the activation process correspond to the activation module. The processing of step S600 (steps S610 and S620) in the flowchart of FIG. 9 or the processing of steps S140 to S160 in the flowchart of FIG. 6 is equivalent to the image formation condition acquisition module. The processing of steps S800 and S820 in the flowchart of FIG. 11 is equivalent to the evaluation information acquisition module. The processing of steps S900 to S980 in the flowchart of FIG. 13 is equivalent to the accounting module. The antenna 82 of the cell phone 80 shown in FIG. 5 corresponds to the information reception/transmission module for the portable device. The processing of steps S100 and S110 in the flowchart of FIG. 5 is equivalent to the startup information transmission control module. The processing of steps S150 and S180 executed by the cell phone 80 in the flowchart of FIG. 6 is equivalent to the image formation condition transmission control module. The processing of steps S240 and S250 executed by the cell phone 80 in the flowchart of FIG. 6 is equivalent to the image transmission control module. The processing of steps S210 and S220 executed by the cell phone 80 in the flowchart of FIG. 6 is equivalent to the evaluation information provision control module.

In the system of the first embodiment, the evaluation information set by the user may include alteration of settings, for example, ‘the enhanced brightness’ ‘the enhanced density by 10%’, and the ‘the enhanced red hue’, with regard to the respective evaluation items including the density of the recording agent and the brightness. The image formation conditions set in the color laser printer 20 are adjusted and updated according to the evaluation information. When an output request is attached to update of the image formation conditions, a selected image is newly formed on a medium under the updated image formation conditions.

In the system of the first embodiment, the evaluation acquisition process is carried out via the cell phone. The evaluation acquisition process may alternatively be carried out via a display unit or an operation unit of the color laser printer 20.

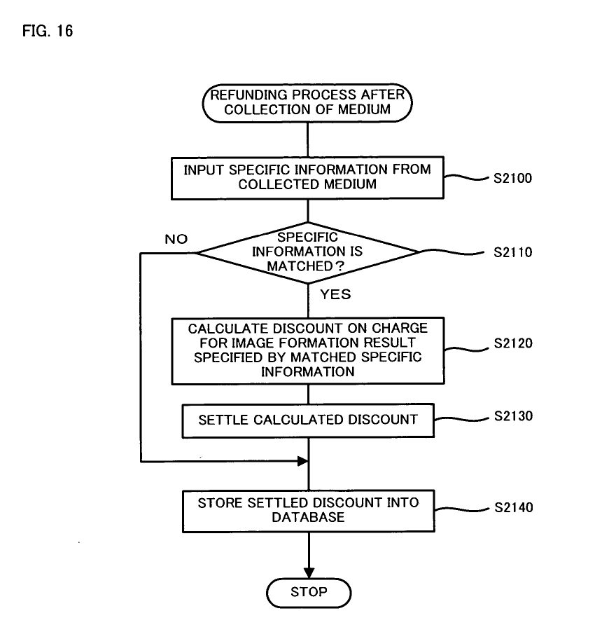

In the system of the first embodiment, the color laser printer 20 has the accounting means to execute the accounting process. The image formation management device 90 may alternatively have accounting management means to execute the entire flow of the accounting process. The image formation management device 90 receives account information for the accounting process, which includes the identification information of the cell phone 80, the results of image formation, and the evaluation information, and executes the accounting process and management based on the received account information. The accounting management means of the image formation management device 90 executes the accounting process on the basis of the results of image formation (including the image formation conditions) and the evaluation information, like the accounting means of the color laser printer 20. When the evaluation information includes a negative evaluation, the image formation management device 90 executes the accounting process with reflection of the negative evaluation. FIGS. 15 and 16 show flows of the accounting process executed by the image formation management device. This processing flow settles a charge for image formation regardless of the result of evaluation, and makes a discount on the charge after extraction of the specific information from a collected medium. In an ordinary accounting process shown in the flowchart of FIG. 15, the image formation management device 90 first receives the account information that includes the cell phone ID, the results of image formation, the printing conditions like the number of prints and the type of printing, and the evaluation information, as well as the specific information that is used to specify the account information, from the color laser printer 20 (step S2000). These received pieces of information are stored in the database 94 of the image formation management device 90. The ordinary accounting process subsequently calculates a charge, based on the obtained pieces of the account information (step S2010) and settles the accounting result without determination of whether the evaluation information includes a negative evaluation (step S2020). The ordinary accounting process stores the accounting result and the account information into the database 94 (step S2030). The ordinary accounting process is here terminated. The image formation management device 90 retrieves the account information from the database 94, sums up the extracted account information with respect to each cell phone ID, and notifies the user identified by the cell phone ID of the accounting, result according to the requirements. A refunding process shown in the flowchart of FIG. 16 is executed in response to collection of a medium with a negative evaluation. The refunding process first inputs the specific information allocated to each collected medium (step S2100), and determines whether the input specific information is identical with the specific information stored in relation to the account information with the negative evaluation in the database 94 (step S2110). When the two pieces of the specific information are matched, the refunding process calculates a discount on the charge for image formation of the collected medium (step S2120), settles the calculated discount as a refund (step S2130), and newly stores the settled refund into the database 94 (step S2140). The refund is subtracted from the accounting result of the user identified by the cell phone ID in a next statement sent to the user. When the evaluation information includes a negative evaluation, one modified procedure may execute the accounting process after collection of a medium with the negative evaluation and input of the specific information allocated to the collected medium. In the image formation management device 90, the processing of step S2000 corresponds to the account information acquisition module and the specific information acquisition module of the invention. The database 94 is equivalent to the account information storage module. The means of executing the processing of step S2100 corresponds to the specific information input module, and the means of executing the processing of step S2110 corresponds to the matching module. The processing of steps S2010 and S2020 in the ordinary accounting process and the processing of steps S2120 and 2130 in the refunding process after collection of the medium are equivalent to the accounting management module.

As described above, the image formation system of this invention receives the identification information of the portable device and the startup information on the electromagnetic waves in the preset frequency band from the portable device and activates the image formation device to be ready for image formation. Simple transmission of the identification information of the portable device and the startup information from the portable device activates the image formation device to be ready for image formation. Namely only the user's simple operations of the portable device are required to start the image formation device for image formation. The image formation system of the invention is thus suitable for the access to the image formation device by the general public. The image formation system has the evaluation information acquisition means to ensure high quality images or the user's desired images. Acquisition of the evaluation information including a negative evaluation enables the image formation system to partially or fully invalidate or cancel the charge for image formation with the negative evaluation, to modify and adjust image formation conditions, to send the evaluation to the image formation management device, and to require the manager of the image formation device for maintenance. Acquisition of the evaluation information including a positive evaluation, on the other hand, enables the image formation system to successively form the remaining images. The image formation system of the invention accordingly provides the user of the portable device with desired images, while adequately charging for image formation.

The image formation system also has the specific information output means to enable the user and the system administrator of the image formation system to readily specify each image formed on the medium and the account information on the formed image. In the event of rejection of a printed image based on the negative evaluation, the image formation system collects the rejected print to identify the portable device that has received the rejected print and to specify the account information on the rejected print. This arrangement verifies the adequacy of the user's evaluation of the image formation.

Second Embodiment

In an image formation system of a second embodiment, the color laser printer 20 has a patch process mechanism to automatically execute the evaluation acquisition process of the first embodiment. The evaluation acquisition process executed by the color laser printer 20 of this embodiment forms a preset test pattern with toner, detects the color density of the toner test pattern, and makes an evaluation based on the detected color density. The color laser printer 20 utilizes the patch process mechanism to function as the test pattern formation means for execution of the evaluation acquisition process and the test pattern detection means for detection of the test pattern. The following description mainly regards such differences from the first embodiment.

The patch process mechanism of the color laser printer 20 forms electrostatic latent images on the photoreceptor 21 in response to a control signal corresponding to a preset pattern given to the exposure unit driving control module, develops the electrostatic latent images with toners to toner images, and transfers the toner images from the photoreceptor 21 onto the transfer belt 24 to form a test pattern. The color laser printer 20 has the color density sensor 34 positioned relative to the transfer belt 24. The color density sensor 34 includes light emitting elements with LED light sources and light receiving elements with photo diodes. The test pattern formed on the surface of the transfer belt 24 is irradiated with light rays emitted from the light emitting elements, and the light receiving elements receive the light rays reflected from the test pattern. The color density sensor 34 for measurement of the color density may have three or more light sources having different emission spectra of, for example, red (R), green (G), and blue (B). The color density sensor 34 may alternatively have one light source for emission of white (W) and three filters of different spectroscopic transmission factors, that is, red, green, and blue, set on the light receiving elements. The color density sensor 34 is designed to irradiate the test pattern formed on the transfer belt 24 with light rays.

The test pattern includes predetermined output patterns suitable for evaluation of the color density. The test pattern may include patch images (for example, solid images or halftone images) of the respective colors, cyan (C), magenta (M), yellow (Y), and black (K).

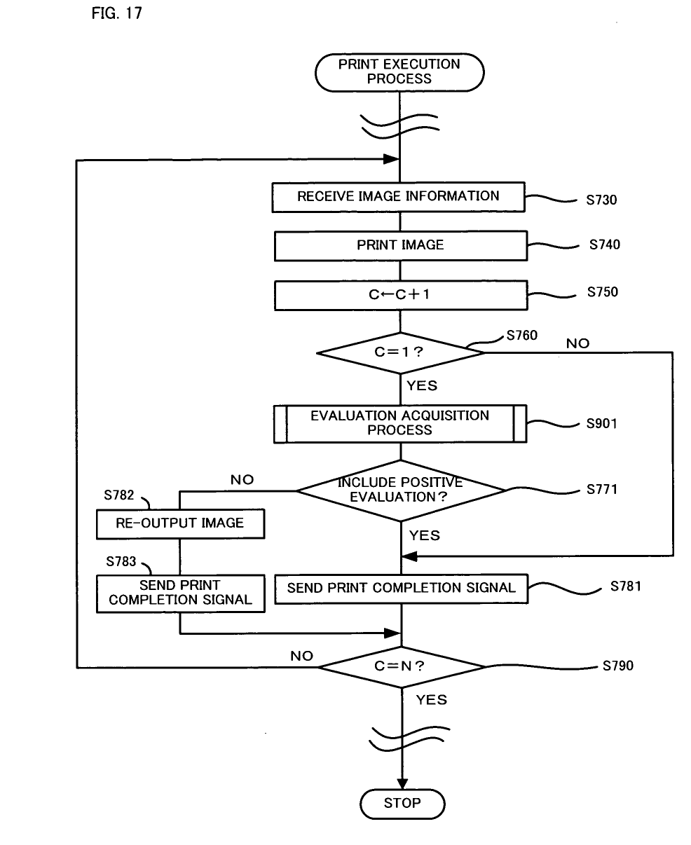

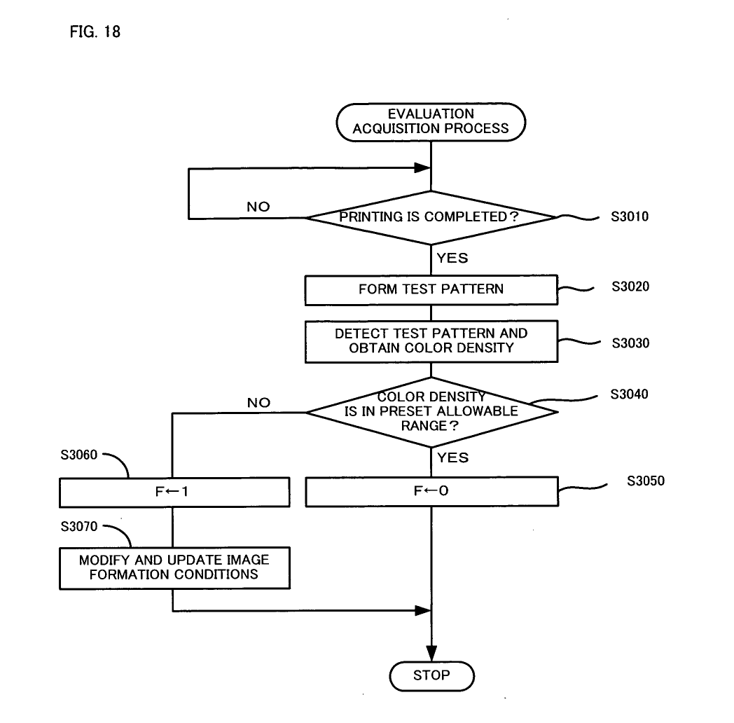

FIG. 17 shows a flow of print execution process executed in the second embodiment. FIG. 18 shows a flow of evaluation acquisition process (step S901) executed in this print execution process. The flow of print execution process of FIG. 17 mainly shows different steps from those in the flow of print execution process of the first embodiment (see FIG. 9). Like the print execution process of the first embodiment, the print execution process of the second embodiment executes an evaluation acquisition process (step S901) after printing a first object image. The evaluation acquisition process detects a print completion signal with regard to a first object image provided by the user after completion of printing of the first object image (step S3010) and forms a preset test pattern on the transfer belt (step S3020). The exposure unit driving control module 64 drives the exposure unit 22 in response to a control signal corresponding to the preset test pattern sent from the CPU 61 and successively forms and exposes output patterns of the respective colors on the photoreceptor 21 with laser beams emitted from the exposure unit 22 to form electrostatic latent images. The electrostatic latent images formed on the photoreceptor 21 are developed with corresponding color toners to form the preset test pattern on the photoreceptor 21. The test pattern is fully transferred onto the transfer belt 24 of the primary transfer unit 25. The test pattern formed on the transfer belt 24 accordingly includes toner patch images of the respective colors.

The evaluation acquisition process subsequently obtains color density information on the test pattern formed on the transfer belt 24 (step S3030). The color density sensor 34 irradiates the toner images of the respective colors formed on the photoreceptor 21 with certain light beams and receives light rays reflected from the toner images. The CPU 61 inputs the quantities of the reflected light rays received by the color density sensor 34 in the form of signals. The evaluation acquisition process then determines whether the input signals representing the quantities of the reflected light rays with regard to the respective colors are in a predetermined allowable range (step S3040). When the signals representing the quantities of the reflected light rays are in the predetermined allowable range to give a positive evaluation, the evaluation acquisition process sets a value ‘0’ to an evaluation flag F (step S3050) and is then terminated. When the signals representing the quantities of the reflected light rays are out of the predetermined allowable range to give a negative evaluation, on the other hand, a value ‘1’ is set to the evaluation flag F (step S3060). The evaluation acquisition process modifies and adjusts the image formation conditions in response to the detected signals representing the quantities of the reflected light rays and writes the modified and adjusted image formation conditions into the EEPROM 74 of the controller 60 to update the previous image formation conditions stored in the EEPROM 74 (step S3070).

When the quantities of the reflected light rays are out of the predetermined allowable range and the test pattern is determined to have an insufficient color density, the image formation conditions are modified and adjusted to lower the surface potential on the photoreceptor 22, enhance the exposure energy, raise the development bias, and increase the toner density. When the test pattern is determined to have an excessive density, on the other hand, the image formation conditions are modified and adjusted inversely.

After execution of the evaluation acquisition process (step S901), the print execution process determines whether the evaluation result includes a positive evaluation or a negative evaluation (step S771). In the case of the positive evaluation (that is, in the case of setting ‘0’ to the evaluation flag F), the evaluation result is sent together with a print completion signal to the user of the cell phone 80 via the reception/transmission system in the preset frequency band between the color laser printer 20 and the cell phone 80 (step S781). The user is accordingly notified of the favorable printing result. In the case of the negative evaluation (that is, in the case of setting ‘1’ to the evaluation flag F), on the other hand, the object image is automatically re-output under the updated image formation conditions (step S782). The user then receives the print completion signal and is notified of the re-output of the image (step S783). After transmission of the print completion signal with regard to the first object image to the user, the print execution process checks the number of prints (step S790) in the same manner as the process of the first embodiment.

As described above, the patch process mechanism of the color laser printer 20 is utilized to attain the evaluation acquisition process and thus stably provides the user with the user's desired, high-quality images. When the formed image has insufficient quality, the user promptly obtains the high-quality re-output image under the modified and adjusted adequate image formation conditions without consciously giving a negative evaluation. This arrangement is especially effective for the color laser printer 20 accessed by the general public. Even in the absence of a printer manager, the color laser printer 20 of this embodiment exerts the self diagnosis function in the image formation process, thus enabling the user to receive the user's desired, high-quality images.

In the image formation system 10 of the second embodiment, the color laser printer 20, its patch process mechanism, and the processing of step S3010 shown in FIG. 17 correspond to the test pattern formation module of the invention. The color density sensor 34 and the processing of steps S3020 and S3030 shown in FIG. 18 correspond to the test pattern detection module. The processing of step S3040 shown in FIG. 18, in addition to all of these, corresponds to the evaluation acquisition module, and the processing of step S3070 corresponds to the image formation condition update module.

The evaluation acquisition process of the second embodiment evaluates the color density of the test pattern. Any one or plurality of other factors, for example, tone, chromaticity, color balance, print thickness, and resist deviation may be used for evaluation, in addition to or in place of the color density. The output mode of the test pattern is set according to the evaluation factors. In the case of monochromatic printers, toner density or ink density, tone, and print thickness are available factors for evaluation.

In the image formation system of the second embodiment, the object of detection is the test pattern formed on the transfer belt 24. This is, however, not restrictive at all. The test pattern may be formed on any medium, which is capable of carry toner images of predetermined patterns formed by the color laser printer 20. For example, the test pattern may be formed on the photoreceptor 21 or a recording medium like paper. In such modifications, a test pattern sensor is arranged at a position adequate for sensing the test pattern formed on the surface of such a medium, for example, at a position in the vicinity of the photoreceptor 21 or at a position in the vicinity of an unloader of the recording medium.

The procedure of the second embodiment automatically executes the evaluation acquisition process by utilizing the patch process mechanism of the printer, after formation of an image. The evaluation acquisition process may alternatively be executed in response to the user's request. In the image formation system of the second embodiment, the evaluation acquisition process is automatically carried out after formation of an image. In the case of printing multiple images or multiple copies, execution of the evaluation acquisition process is required for only the first image or copy. One possible modification may start actual image printing after execution of the evaluation acquisition process.

The procedure of the second embodiment automatically re-outputs an image with a negative evaluation under updated image formation conditions. One modified procedure sends a negative evaluation given to an image to the user via the reception/transmission system, receives a response to an inquiry about requirement of re-output from the user, and re-outputs the image according to the requirement. In one concrete example of such modification, notification of the evaluation result and inquiry about the requirement of re-output are shown on a display unit of the color laser printer 20. The user manipulates an operation unit of the color laser printer 20 to enter the response.

In the image formation system of the second embodiment, the negative evaluation given in the evaluation acquisition process may be reflected on the accounting result. Any of other applicable arrangements and possible modifications described above with regard to the first embodiment is also applicable to the image formation system of the second embodiment.

As described above, the image formation system of the second embodiment has the evaluation acquisition means using the test pattern. This arrangement enables self diagnosis of the image formation device and gives the highly objective evaluation information. The image formation system of the second embodiment also has the update means and thereby ensures formation of an image under adequate settings of image formation conditions. Re-output of an image with a negative evaluation on the medium under updated image formation conditions ensures formation of the user's desired, high-quality image.

Third Embodiment

In an image formation system of a third embodiment, the evaluation acquisition process uses the image scanning means, such as a scanner, to scan an output image for evaluation. The primary difference from the evaluation acquisition process of the second embodiment is that the evaluation acquisition process executed by a color laser printer 120 of the third embodiment makes an evaluation based on image evaluation information input from a scanner 40. Unlike the color laser printer 20 of the second embodiment, the color laser printer 120 of the third embodiment has the scanner 40 as an image scanning unit. The following description mainly regards such differences from the second embodiment.

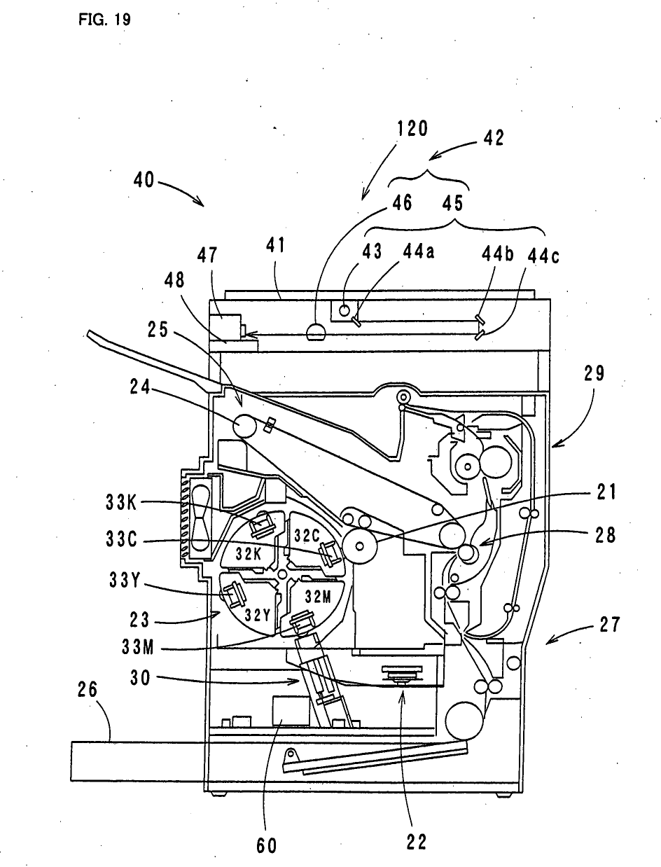

FIG. 19 shows the structure of the color laser printer 120 including the scanner 40. The scanner 40 has a copyholder 41, an optical system 42, a CCD line sensor 47, and a signal processing unit 48. The optical system 42 includes an exposure lamp 43 for irradiating a print with light rays, a carriage 45 equipped with mirrors 44a through 44c for reflecting light rays from the irradiated print, and a condenser lens 46. The carriage 45 is arranged to be movable in a sub-scanning direction to focus the reflected light rays from an image of the print set on the copyholder 41 onto the CCD line sensor 47. The CCD line sensor 47 has a CCD array aligned in a scanning width (in a main scanning direction) to convert the reflected light rays from the print into electric signals (analog signals) of red (R), green (G), and blue (B) and output the converted analog signals into the signal processing unit 48. The signal processing unit 48 processes the input analog signals of red, green, and blue with an A/D converter and an encoder into digital image data of the respective color channels and outputs the digital image data to the CPU 61.

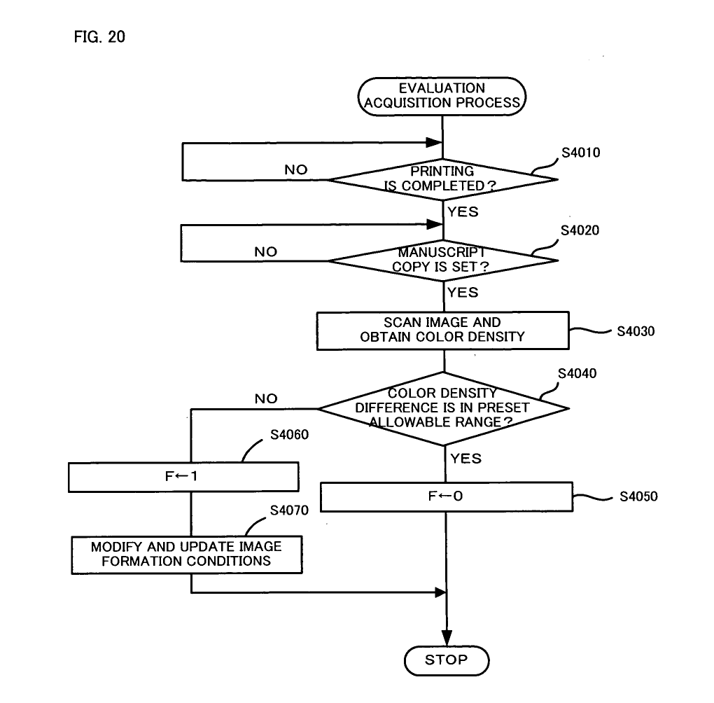

A flow of print execution process executed in the third embodiment is identical with the flow of the print execution process executed in the second embodiment, except the details of the evaluation acquisition process. FIG. 20 shows a flow of the evaluation acquisition process executed in the print execution process of the third embodiment. The evaluation acquisition process of the third embodiment first obtains image data (step S4030). According to the concrete procedure, the CPU 61 detects a print completion signal with regard to a first object image (step S4010), senses that a print with the first object image printed thereon has been set on the copyholder of the image scanning unit (step S4020), and activates the image scanning unit to scan the output image on the print and obtain digital color density data (step S4030).

The CPU 61 then compares the obtained color density data with reference color density data printed in advance and stored in the RAM for evaluation to calculate color density difference data, and determines whether the calculated color density difference data is in a preset allowable range (step S4040). When the color density difference data is in the preset allowable range to give a positive evaluation on the output image, the CPU 61 sets a value ‘0’ to the evaluation flag F (step S4050) When the color density difference data is out of the preset allowable range to give a negative evaluation on the output image, on the other hand, the CPU 61 sets a value ‘1’ to the evaluation flag F (step S4060). The CPU 61 then modifies and adjusts the image formation conditions with regard to the toner densities of Y, M, C, and K and writes the modified and adjusted image formation conditions into the EEPROM 74 of the controller 60 to update the image formation conditions stored in the EEPROM 74 (step S4070).

The image formation conditions may be modified and adjusted according to the obtained color density to lower the surface potential of the photoreceptor 22, like the procedure of the second embodiment. Another applicable procedure may correct RGB data given by the user and stored with scanned RGB data and modify and adjust the image formation conditions based on the corrected RGB data.

In the image formation system of the third embodiment, in the case of a positive evaluation, the evaluation result is sent to the user via the reception/transmission system in the preset frequency band between the color laser printer 120 and the cell phone 80, as in the second embodiment. The user is accordingly notified of the good printing result. The evaluation result may be shown on a display unit of the color laser printer 120. When the image formation conditions are updated on the basis of a negative evaluation, an image with the negative evaluation may automatically be re-output under the updated image formation conditions. Another applicable procedure may send the negative evaluation to the user via the reception/transmission system, receive a response to an inquiry about requirement of re-output from the user, and re-output the image according to the requirement. In this modified procedure, the notice of evaluation result may be shown on the display unit of the color laser printer 20, and the user may manipulate an operation unit of the color laser printer 20 to enter the requirement or non-requirement of re-output.

The image formation system of the third embodiment exerts the similar effects to those of the image formation system of the second embodiment. The procedure of the third embodiment scans an output image to obtain image information and makes an evaluation based on the obtained image information. The evaluation acquisition process may thus be designed to be suitable for the respective types of output images and various image elements, for example, texts (letters and characters), pictures (photographs), graphics (graphs), and mixtures thereof. In text areas and graphic areas, evaluation and correction may be focused on the print thickness and the sharpness. In picture areas, evaluation and correction may be focused on the color reproducibility.

In the image formation system of the third embodiment, the scanner 30 and the processing of step S4030 shown in FIG. 20 correspond to the image scanning module of the invention. The processing of step S4040 shown in FIG. 20, in addition to all of these, corresponds to the evaluation acquisition module.

The procedure of the third embodiment evaluates the color density of the image data scanned by the scanner 40. Any one or plurality of other factors, for example, tone, chromaticity, color balance, print thickness, and resist deviation may be used for evaluation, in addition to or in place of the color density. Such required pieces of information for evaluation may be obtained in the course of scanning an image by the scanner 40 or in the course of processing image information.

In the image formation system of the embodiment, the scanner 40 built in the color laser printer 120 is used to acquire the evaluation information. The scanner 40 may be provided separately from the color laser printer 120.

The image formation system of the embodiment executes the evaluation acquisition process in response to the user's setting of an output image on the image scanning unit after image formation. Prior to delivery of a print with an image printed thereon from the color laser printer 120, the print may automatically be conveyed to the image scanning unit by a conveyance mechanism provided separately in the color laser printer 120. The image scanning unit scans the printed image to obtain image data. In the image formation system of the third embodiment, the negative evaluation given in the evaluation acquisition process may be reflected on the accounting result. Any of other applicable arrangements and possible modifications described above with regard to the first embodiment is also applicable to the image formation system of the third embodiment.

As described above, the image scanning means as part of the evaluation acquisition means gives the evaluation information without using any test pattern and enables evaluation based on an image formed on the medium.

In the embodiments discussed above, the image formation system 10 includes the color laser printer 20 or 120 as the image formation device. The image formation device is, however, not restricted to the color laser printer but may be any of various printers including monochromatic laser printers and inkjet printers. The technique of the invention is not restricted to the printers but is also applicable to diversity of other image formation devices, such as photocopiers and complex machines. The printing type and the evaluation acquisition process are modified and changed according to the type of the image formation device.

In the embodiments discussed above, the image formation system 10 inputs the number of prints and the printing type. The number of prints and the printing type may, however, not be input but set in advance.

In the embodiments discussed above, the image formation system 10 includes the cell phone 80 as the portable device. The portable device is, however, not restricted to the cell phone 80. The electromagnetic waves in the information reception/transmission frequency band are not limited to the electromagnetic waves in the frequency band specifically used for cell phones but may be electromagnetic waves in a different frequency band. When the cell phone 80 is used as the portable device, the electromagnetic waves in the information reception/transmission frequency band between the information transmission module 50 of the color laser printer 20 and the cell phone 80 are not limited to the electromagnetic waves in the frequency band specifically used for cell phones. The cell phone 80 may have a reception/transmission circuit for reception and transmission with electromagnetic waves in another frequency band and a corresponding antenna. The cell phone 80 may have a switchover function between communication with the information transmission module 50 and communication via the communication system 12.

In the above embodiments, the acquired evaluation information is reflected on the accounting result and is sent to the image formation management device 90. The color laser printer 20 or 120 may be designed to modify and adjust the image formation conditions and to demand for maintenance.

In the image formation system 10 of the above embodiments, the color laser printer 20 has the information transmission module 50. The printer service information, the identification information, and the authentication data are stored in the memory cell 55 of the information transmission module 50. These information and data may alternatively be stored in the control unit 56 or in the controller 60. The storage elements 33C, 33M, 33Y, and 33K mounted on the respective toner cartridges 32C, 32M, 32Y, and 32K set in the color laser printer 20 may have the functions of the information transmission module 50.

The embodiments discussed above regard the image formation system 10 of the invention. The technique of the invention is also attained by diversity of other applications, for example, an image formation device like the color laser printer 20 used in the image formation system 10 of the embodiments, a portable device like the cell phone 80 used in the image formation system 10 of the embodiments, and an image formation management device like the image formation management device 90 used in the image formation system 10 of the embodiments. The technique of the invention is also actualized by an image formation method corresponding to the image formation system 10 of the embodiments.

The above embodiments are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The disclosure of Japanese Patent Applications No.2003-287905 filed on Aug. 6, 2003 and No.2004-226747 filed on Aug. 3, 2004, including specifications, drawings, and claims is incorporated herein by reference in its entity.

1. An image formation system comprising an image formation device that forms an image on a medium, such as paper, and a portable device that receives and sends information carried on electromagnetic wave in a preset frequency band,
said image formation device comprising:
an image formation device information reception/transmission module that receives and transmits information carried on the electromagnetic wave in the preset frequency band;
an activation module that activates said image formation device to be ready for image formation, in response to reception of identification information of said portable device and a predetermined piece of startup information by said image formation device information reception/transmission module;
an image formation condition acquisition module that, when said image formation device is activated in response to reception of the predetermined piece of startup information, sends a preset condition entry request to a sender, which has sent the predetermined piece of startup information, and acquires an image formation condition via said image formation device information reception/transmission module; and
an image formation execution module that receives an image sent from the sender, which has sent the predetermined piece of startup information, as a response to a preset image transmission request via said image formation device information reception/transmission module and forms the received image on the medium under the acquired image formation condition,
said portable device comprising:
a portable device information reception/transmission module to receive and transmit information carried on the electromagnetic wave in the preset frequency band;
an input module that is operated for entry of information;
an identification information storage module that stores the identification information of said portable device;
a startup information transmission control module that controls said portable device information reception/transmission module in response to entry of the predetermined piece of startup information by a specified operation of said input module to send the predetermined piece of startup information and the identification information of said portable device stored in said identification information storage module;
an image formation condition transmission control module that controls said portable device information reception/transmission module to require an operator of said portable device for entry of the image formation condition in response to the preset condition entry request and send the image formation condition entered in response to the preset condition entry request; and
an image transmission control module that controls said portable device information reception/transmission module to require the operator of said portable device for selection of the image in response to the preset image transmission request and send the image selected in response to the preset image transmission request.

2. An image formation system in accordance with claim 1, wherein said image formation device further comprises an evaluation acquisition module that acquires evaluation information with regard to the image formed on the medium.

3. An image formation system in accordance with claim 2, wherein said evaluation acquisition module acquires an evaluation given by the operator of said portable device.

4. An image formation system in accordance with claim 3, wherein said evaluation acquisition module sends a preset evaluation transmission request to said portable device and acquires the evaluation information with regard to the formed image via said image formation device information reception/transmission module, and
said portable device further comprises an evaluation provision module that requires the operator of said portable device for entry of the evaluation with regard to the formed image in response to reception of the preset evaluation transmission request and sends the evaluation information entered in response to the preset evaluation transmission request via said portable device information reception/transmission module.

5. An image formation system in accordance with claim 2, wherein said evaluation acquisition module acquires an evaluation given by said image formation device.

6. An image formation system in accordance with claim 5, wherein said evaluation acquisition module comprises: a module that prepares a test pattern on an image carrier in said image formation execution module after formation of the image on the medium; a module that measures a recording agent density of the test pattern; and a module that evaluates the image formed on the medium based on the measured recording agent density.

7. An image formation system in accordance with claim 6, wherein said evaluation acquisition module forms the test pattern, in response to reception an evaluation acquisition request sent from said portable device.

8. An image formation system in accordance with claim 5, wherein said evaluation acquisition module comprises: an image scanning module that scans the image formed on the medium by said image formation execution module; and an evaluation module that makes an evaluation of the image formed on the medium based on an image density, which is extracted from the formed image scanned by said image scanning module.

9. An image formation system in accordance with claim 2, wherein said image formation device further comprises an update module that modifies, adjusts, and updates the image formation condition set in said image formation device, based on an image density detected by said evaluation acquisition module.

10. An image formation system in accordance with claim 9, wherein said image formation execution module forms the image again on the medium under the updated image formation condition, when the image formation condition set in said image formation device is updated.

11. An image formation system in accordance with claim 2, wherein said image formation device further comprises an accounting module that carries out an accounting process based on a result of image formation by said image formation execution module and the evaluation information.

12. An image formation system in accordance with claim 11, wherein said accounting module, when the acquired evaluation information includes a negative evaluation, carries out the accounting process to at least reduce a charge for the result of image formation with the negative evaluation.

13. An image formation system in accordance with claim 2, wherein said image formation device further comprises a specific information output module that outputs specific information, which is capable of specifying the account information including the identification information of said portable device, the result of image formation by said image formation execution module, and the evaluation information, on the medium with the image formed thereon.

14. An image formation system in accordance with claim 2, said image formation system further comprising an image formation management device that is connectable with said image formation device via a communication system,
said image formation management device comprising:
an account information acquisition module that obtains account information, which includes the identification information of said portable device, a result of image formation by said image formation execution module, and evaluation information corresponding to the result of image formation, from said image formation device via the communication system; and
an accounting management module that carries out an accounting process based on the account information.

15. An image formation system in accordance with claim 14, wherein said accounting management module, when the acquired evaluation information includes a negative evaluation, carries out the accounting process to at least reduce a charge for the result of image formation with the negative evaluation.

16. An image formation system in accordance with claim 14, wherein said image formation device further comprises a specific information output module that outputs specific information, which is capable of specifying the account information including the identification information of said portable device, the result of image formation by said image formation execution module, and the evaluation information, on the medium with the image formed thereon, and
said image formation management device further comprises:
a specific information acquisition module that obtains the specific information from said image formation device via the communication system; and
an account information storage module that stores the account information in relation to the specific information that specifies the account information.

17. An image formation system in accordance with claim 16, wherein said image formation management device further comprises:
a specific information input module that, in response to collection of a medium of image formation with a negative evaluation included in the evaluation information, inputs the specific information output on the medium; and
a matching module that determines whether the specific information input by said specific information input module matches with the specific information that has been stored in said account information storage module in relation to the account information including the evaluation information of a negative evaluation.

18. An image formation device that forms an image on a medium, such as paper, said image formation device comprising: an image formation device information reception/transmission module that receives and transmits information carried on electromagnetic wave in a preset frequency band; an activation module that activates said image formation device to be ready for image formation, in response to reception of identification information of a portable device and a predetermined piece of startup information by said image formation device information reception/transmission module; an image formation condition acquisition module that, when said image formation device is activated in response to reception of the predetermined piece of startup information, sends a preset condition entry request to a sender, which has sent the predetermined piece of startup information, and acquires an image formation condition via said image formation device information reception/transmission module; and an image formation execution module that receives an image sent from the sender, which has sent the predetermined piece of startup information, as a response to a preset image transmission request via said image formation device information reception/transmission module and forms the received image on the medium under the acquired image formation condition.

19. A portable device that sends and receives information carried on electromagnetic wave in a preset frequency band, to and from an image formation device that forms an image on a medium, such as a paper, said portable device comprising: a portable device information reception/transmission module to receive and transmit information carried on the electromagnetic wave in the preset frequency band; an input module that is operated for entry of information; an identification information storage module that stores the identification information of said portable device; a startup information transmission control module that controls said portable device information reception/transmission module in response to entry of a predetermined piece of startup information by a specified operation of said input module to send the predetermined piece of startup information and the identification information of said portable device stored in said identification information storage module; an image formation condition transmission control module that controls said portable device information reception/transmission module to require an operator of said portable device for entry of an image formation condition in response to a preset condition entry request and send the image formation condition entered in response to the preset condition entry request; an image transmission control module that controls said portable device information reception/transmission module to require the operator of said portable device for selection of an image in response to a preset image transmission request and send the image selected in response to the preset image transmission request; and an evaluation provision module that requires the operator of said portable device for entry of an evaluation with regard to a formed image in response to reception of a preset evaluation transmission request from said image formation device, and sends the evaluation information entered in response to the preset evaluation transmission request via said portable device information reception/transmission module.

20. An image formation management device used in an image formation system which comprises an image formation device that forms an image on a medium, such as paper, and a portable device that receives and sends information carried on electromagnetic wave in a preset frequency band,
said image formation device comprising: an image formation device information reception/transmission module that receives and transmits information carried on the electromagnetic wave in the preset frequency band; an activation module that activates said image formation device to be ready for image formation, in response to reception of identification information of said portable device and a predetermined piece of startup information by said image formation device information reception/transmission module; an image formation condition acquisition module that, when said image formation device is activated in response to reception of the predetermined piece of startup information, sends a preset condition entry request to a sender, which has sent the predetermined piece of startup information, and acquires an image formation condition via said image formation device information reception/transmission module; an image formation execution module that receives an image sent from the sender, which has sent the predetermined piece of startup information, as a response to a preset image transmission request via said image formation device information reception/transmission module and forms the received image on the medium under the acquired image formation condition; and an evaluation acquisition module that acquires evaluation information with regard to result of the image formed on the medium,
said image formation management device comprising: an account information acquisition module that obtains account information, which includes the identification information of said portable device, a result of image formation by said image formation execution module, and evaluation information corresponding to the result of image formation, from said image formation device via the communication system; and an accounting management module that carries out an accounting process based on the account information.
